(19) United States
(12) Patent Application Publication
(10) Pub. No.: US 2016/0206137 A1
(43) Pub. Date: Jul. 21, 2016

(54) LID SUPPORT AND POSITIONER FOR RESIDING ATOP A HANDLE OF A COOKING VESSEL FOR UNDERLYING AND ASSISTING TO SUPPORT A COVER OR LID IN AN OFF-CENTER POSITION ATOP THE VESSEL

(71) Applicant: J. KEVIN WIGGINS, Elyria, OH (US)

(72) Inventor: J. KEVIN WIGGINS, Elyria, OH (US)

(21) Appl. No.: 14/602,079

(22) Filed: Jan. 21, 2015

(51) Int. Cl. A47J 36/12

(52) U.S. Cl. CPC A47J 36/12

(57) ABSTRACT

The present invention relates to a lid support and positioner that is quite versatile in how it can cooperate with the handle of cooking vessels to overly the handle, and to underly, engage and provide support for a cover or lid of the cooking vessel that is positioned off center relative to an upward opening cooking chamber of the vessel to permit the cooking chamber to breathe so as to minimize or prevent bubble-over or boil-over of cooking fluids. When used with cooking vessels that have elongate handles, the lid support and positioner may be adjustable positioned on the length of the handle to underly, engage and support a peripheral portion of an off-center cover or lid at a range of locations where the lid selectively covers/uncovers different proportions of the cooking chamber to thereby regulate and control the cooking temperature within the cooking chamber.

### BACKGROUND

Cooking vessels such as pots and pans that have upstanding side walls surrounding upwardly opening cooking chambers in which foods are heated and cooked typically contain cooking fluids that can bubble over or boil over, especially when the cooking chambers are fully covered, which can cause cooking temperatures within the cooking chambers rising to inappropriate magnitudes. Leaving the upwardly opening cooking chambers completely uncovered can also permit cooking fluids to splatter about. Accordingly, in many situations, neither fully covered nor fully uncovered cooking chambers provide desirable results.

A technique commonly used by cooks to eliminate bubble-over, and to regulate or control temperature within the cooking chamber of a cooking vessel being heated is to adjustably position the cover or lid of the cooking vessel off-center, so that, during heating or cooking, only a selected portion of the upwardly opening cooking chamber of the vessel is covered, and a remaining portion of the cooking chamber is deliberately left uncovered. This technique, when used during cooking, provides a simple and straightforward technique for regulating and controlling the temperature within the cooking chamber, and permits bubble-over or boil-over to be minimized.

A problem with positioning a cover or a lid off-center (which term is used herein to mean “extending substantially horizontally atop only a portion of the rim or top edge of a vessel's cooking chamber”) is that the portion of the cover or lid that extends outside and beyond the periphery of the vessel's cooking chamber is entirely unsupported—meaning that it extends in a cantilevered fashion—whereby the cantilevered and off-center cover or lid may fall off, or can easily be accidentally knocked or brushed completely off of the associated cooking vessel, which may cause hot cooking fluid such as hot cooking grease and the like to be splattered or spilled onto a floor and/or near to a stove or cooktop that is being used to heat the cooking vessel.

U.S. Pat. No. 2,879,915 which issued Mar. 31, 1959 to Joseph R. Medor (the disclosure of which us uncorporated herein by reference) recognizes the need for providing underlying support for an off-center lid situated atop a cooking vessel. However, the Medor patent addresses this need by proposing a metal clip that is designed to extend into, and to overlie an interior portion of the cooking chamber of a cooking vessel. The proposed clip of Medor underlies and is designed to offer added support for only the part of and off-center cover or lid that overlies the vessel's cooking chamber, and does nothing to underlie and support the part of an off-center cover or lid that extends in a cantilevered fashion beyond the perimeter of the vessel's cooking chamber.

A significant drawback of the Medor clip is that it overlies only an inside portion of a cooking chamber of the cooking vessel on which it is installed. The clip is not intended to underlie and support any part of a off-center cover or lid that extends outside of and beyond the perimeter of the cooking chamber of a cooking vessel—which is the part of a off-center cover of lid that is most likely to be accidentally struck and unintentionally brushed off the associated cooking vessel.

A further drawback of the Medor clip is that it is not intended to aid in adjustably positioning an off-center lid through a wide range of movement so that a significant portion of the area of a cover or lid can extend outside the perimeter of the cooking chamber of a cooking vessel while the cover or lid is still being supported by the relatively short Medor clip.

Inasmuch as the Medor clip is intended to be used to overlie a cooking chamber where hot grease and cooking fluids are likely to be bubbling and splattering about, clearly the clip is intended to be grasped, repositioned and adjusted only when the associated cooking vessel is out of service, not while cooking fluids are being heated and are bubbling about—i.e., not while cooking is underway.

Another drawback of the Medor clip is its likelihood of becoming covered with grease and other splatter, necessitating that the clip frequently be removed to be cleaned.

Still another drawback of the Medor clip is that it in no way makes use of the handle of the cooking vessel on which the clip is installed to underlie and to provide support for an off-center cover or lid. Further, the clip proposed by Medor is designed to take a rigid form that offers no resilience and no capability to adjustably grip cooking vessel portions of differing size, and having no memory for returning to an initial shape after being deformed temporarily to grip a cooking vessel handle or the like.

Neither recognized in nor appreciated by the Medor patent is the fact that the significant degree of temperature control can advantageously be obtained by modifying and adjusting the covered and uncovered areas of the cooking chamber of a cooking vessel. The patent neither recognizes nor suggest taking advantage of the fact that, by increasing the size of an uncovered area of a cooking chamber, cooking temperature can easily be decreased because more heat is permitted to escape; or that, by decreasing the size of the uncovered area of a cooking chamber, an increase in cooking temperature can easily be obtained.

### SUMMERY

In preferred practice, a lid support and positioner is provided that is configured for versatility in that it can be used in cooperation with cooking vessel handles of a wide variety of types and shapes to support and off-center cover or lid so temperature can be regulated within the vessel's cooking chamber.

In preferred practice, a lid support and positioner is provided that is designed to overlie a selected portion of a handle of a cooking vessel, and to underlie, engage and provide support for a peripheral region of an off-center cover or lid that extends beyond the periphery of the cooking chamber of the vessel—namely a portion of the off-center cover or lid that overlies a part of the vessels handle.

In preferred practice, a lid support and positioner is provided that easily can be adjustably positioned along the length of an elongate handle of a cooking vessel to underlie, engage and support at various selected locations a peripheral region of an off-center cover or lid that extends beyond the periphery of the cooking chamber of the cooking vessel and overlies a part of the vessel's elongate handle.

In preferred practice, a lid support and positioner is formed from resilient material and is configured to resiliently grip, and to thereby be retained on, a handle of a cooking vessel—which renders the lid support and positioner particularly versatile when used with cooking vessels that have elongate handles along which a lid support and positioner can be adjusted to underlie, engage and support portions of off-center covers or lids that may extend significantly different distances while being adjustably positioned to overlie different lengths of the elongate handle of a cooking vessel.

In preferred practice, a lid support and positioner is configured 1) to engage, underlie and provide auxiliary support to a cantilevered portion of a cover or lid that is positioned off-center atop the rim or top edge of a cooking vessel, and 2) to resiliently grip and thereby be retained on an elongate handle of a cooking vessel as the lid support and positioner is adjustably positioned along an elongate handle of the cooking vessel.

In preferred practice, a lid support and positioner is provided that renders it quite easy to set and adjust throughout a wide range of movement the extent to which a cover or lid is positioned off-center while resting atop a rim or top edge of an upstanding sidewall of a cooking vessel, whereby the temperature within a cooking chamber of the vessel can be easily regulated to minimize or prevent bubble-over, boil over and grease splatter.

In some embodiments, a lid support and positioner is a one-piece member in the form of non-planar endless ring to annular loop of resilient material that is shaped to be installable one a wide variety of cooking vessel handles to receive or even to adjustably grip the elongate handle of the cooking vessel while overlying the handle to provide underlying support for a portion of an off-center cover or lid that extends beyond the perimeter of an upwardly opening cooking chamber of the cooking vessel.

In some embodiments, a lid support and positioner provides and upwardly extending projection suited to underlie and/or engage a portion of an off-center cover or lid that extends in a cantilevered fashion beyond the perimeter of an upwardly opening cooking chamber of a cooking vessel, to assist in positioning the off-center cover or lid so the temperature within the cooking chamber can be regulated by controlling the extent to which the off-center cover or lid over lies and leaves uncovered selected areas of the cooking chamber.

In preferred practice, a lid support and positioner is configured 1) to engage, underlie and provide auxiliary support to a cantilevered portion of a cover or lid that is positioned off-center atop the rim or top edge of a cooking vessel, and 2) to resiliently grip and thereby be retained on an elongate handle of a cooking vessel as the lid support and positioner is adjustably positioned along an elongate handle of the cooking vessel.

In preferred practice, a lid support and positioner is provided that renders it quite easy to set and adjust throughout a wide range of movement the extent to which a cover or lid is positioned off-center while resting atop a rim or top edge of an upstanding sidewall of a cooking vessel, whereby the temperature within a cooking chamber of the vessel can be easily regulated to minimize or prevent bubble-over, boil over and grease splatter.

In some embodiments, a lid support and positioner is a one-piece member in the form of non-planar endless ring to annular loop of resilient material that is shaped to be installable on a wide variety of cooking vessel handles to receive or en to adjustably grip the elongate handle of the cooking vessel while overlying the handle to provide underlying support for a portion of an off-center cover or lid that extends beyond the perimeter of an upwardly opening cooking chamber of the cooking vessel.

In some embodiments, a lid support and positioner provides and upwardly extending projection suited to underlie and/or engage a portion of an off-center cover or lid that extends in a cantilevered fashion beyond the perimeter of an upwardly opening cooking chamber of a cooking vessel, to assist in positioning the off-center cover or lid so the temperature within the cooking chamber can be regulated by controlling the extent to which the off-center cover or lid over lies and leaves uncovered selected areas of the cooking chamber.

In some embodiments, a lid support and positioner takes the form of a non-planar endless ring or annular loop of resilient material which extends about a central opening that is configured to permit an elongate handle of a cooking vessel to extend therethrough, with the lid positioner be adapted to permit spreading of its opposed portions to resiliently grip opposed surfaces of the handle aid in retaining the lid support and positioner at desired locations along the length of the handle, with the lid positioner also having an elongate portion projecting therefrom that can be oriented to extend generally upwardly from a exterior surface of the annular ring for engaging a perimetrically extending region of a cover or lid in an off-center position supported atop and partially overlying a portion of the handle of the associated cooking vessel.

### DESCRIPTION OF DRAWINGS

These and other features, and a fuller understanding of the present inventions may be had by referring to the following description and claims, taken in conjunction with the accompanying drawings wherein:

FIG. 1 is a perspective view of a lid support and positioner depicting one possible embodiment of the present invention;

FIG. 2 is a left side view thereof, it being understood that a right side view is a left-to-right reversed mirror image thereof;

FIG. 3 is a sectional view as seen from a plane indicated by a line 3-3 in FIG. 2;

FIG. 4 is a front elevation view thereof;

FIG. 5 is a sectional view as seen from a plane indicated by line 5-5 in FIG. 3;

FIG. 6 is a rear elevation view thereof;

FIG. 7 is a top plan view thereof;

FIG. 8 is a bottom plan view thereof;

FIG. 9 is a perspective view showing the lid support and positioner in one possible orientation on a handle on a first type of a cooking vessel;

FIG. 10 is a perspective view similar to FIG. 8 showing the lid support and positioner underlying and assisting to support a cover or lid in an off-center position atop the first type of cooking vessel in FIG. 9;

FIG. 11 is a perspective view that also similar to FIG. 8 showing the lid support and positioner an another possible orientation on a handle of the first type of a cooking vessel;

FIG. 12 is a perspective view similar to FIG. 11 showing the lid support and positioner and yet another possible orientation on a handle of the first type a cooking vessel underlying and assisting to support a cover or a lid in an off-center position atop the first type of cooking vessel;

FIG. 13 is a perspective view showing the lid support and positioner in one possible orientation on a handle of a second type of cooking vessel; and

FIG. 14 is a perspective view similar to FIG. 13 showing the lid support and positioner in an alternate orientation underlying and assisting to support a cover or lid in an off-center position atop the second type of cooking vessel.

### DESCRIPTION

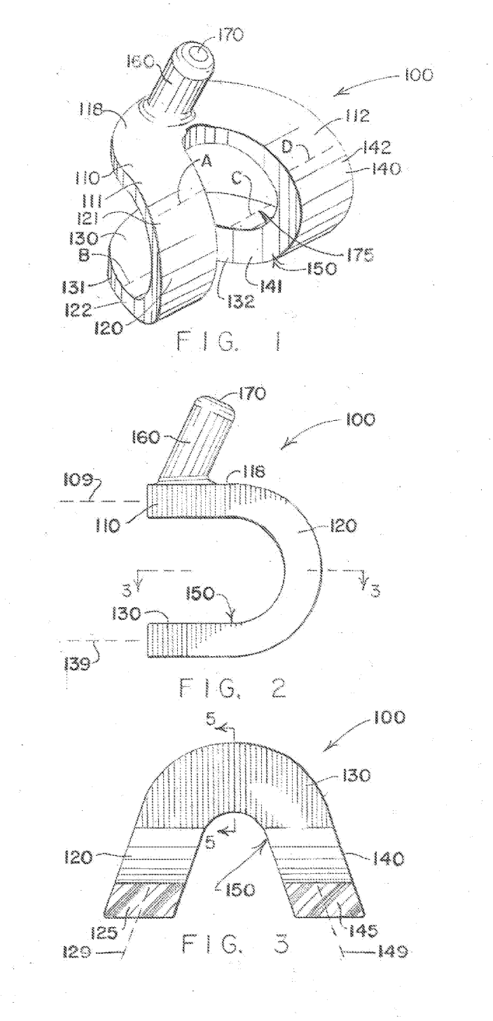

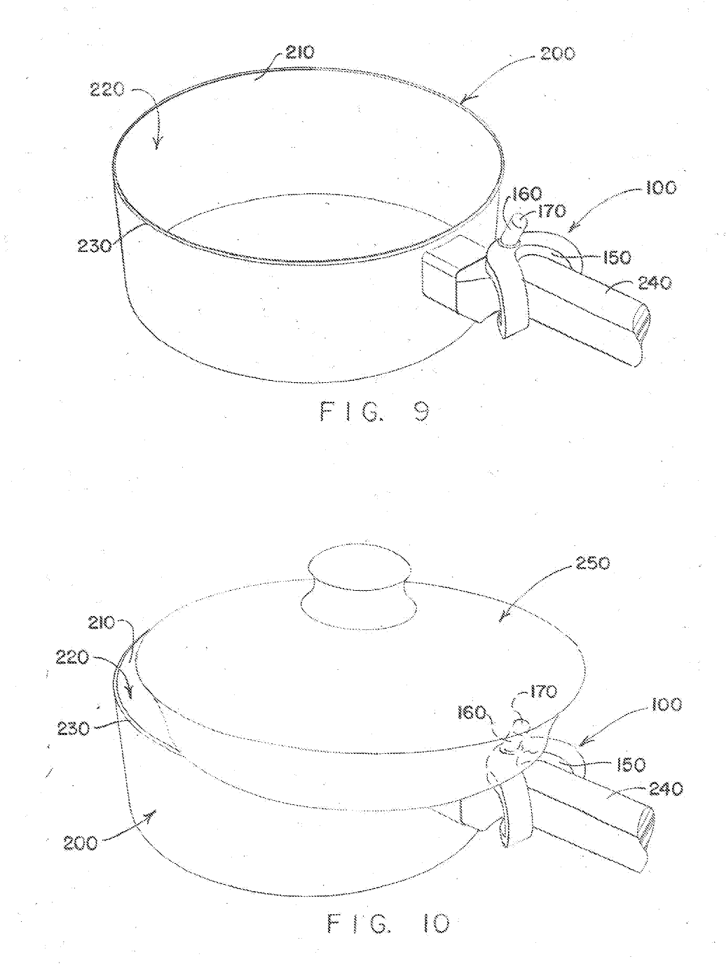

Referring to FIGS. 1-2, 4 and 6-8, a one piece lid support and positioner 100 is shown that depicts one possible and preferred embodiment of the invention. As will be readily apparent to and understood by those who are skilled in the art, a lid support and positioner that embodies features of the present invention may take any of a wide variety of forms and configurations that offer such features and versatility as is described herein. The depicted lid support and positioner embodiment 100 is primarily formed by continuos, endless ring or annular loop of material indicated generally by the 150 which extends about in circles a central opening 175 which is best shown in FIGS. 4 and 6.

In preferred practice, the material forming the whole of the one piece lid support and positioner 100 is selected to be a relatively resilient material having a memory that tends to return the endless ring or annular loop 150 to the configuration shown in FIGS. 1-2, 4 and 6-8 if forced is released that has been applied to the lid support and positioner 100 to cause the continuous, endless ring annular loop of material 150 to take slightly a different form, configuration or shape such as may occur if the lid support and positioner 100 is slightly stretched to receive, or to grip opposed surfaces of a handle of a cooking vessel, as may take place when the lid support and positioner is installed on a handle of a cooking vessel as depicted in FIGS. 9-11 hereof.

The endless ring or annular loop 150 that forms a majority of the lid support and positioner 100 is defined by contiguously extending set or sequence of four nonplanar, generally c-shape portions 110,120, 130, 140 that (referring only to FIG. 1) can perhaps be said to be separated from one another by four imaginary lines that are labeled by the letters A,B, C and D.

If the imaginary lines A, B, C, and D can be thought of as designating imaginary “ends” of the C-shaped portions 110,120, 130, 140, then the C-shaped top portion 110 can perhaps be said to have a first “end” 111 that joins along the imaginary line A with the first “end” 121 of the C-shaped left side portion 120; the C-shaped left side portion can perhaps be said to have a second “end” 122 that joins smoothly along the imaginary line B with a first “end” 131 of the C-shaped bottom portion 130; the C-shaped bottom portion 130 can perhaps be said to have a second “end” 132 that joins smoothly along the imaginary line D with a first end 141 of the C-shaped right side portion 140; and the C-shaped right side right side portion 140 can perhaps be said to have a second end region 142 that joins smoothly with a second end region 112 of the C-shaped top portion 110. As such, the four C-shaped portions 110, 120, 130, 140 complete the contiguous endless ring or annular loop 150 that forms the majority of the lid support and positioner 100. Moreover, the contiguously extending C-shape top, left side, bottom and right side portions 110, 120, 130, 140, respectively, that form the endless ring or annular loop 150 cooperate to encircle the open central area or opening 175 best shown in FIGS. 4 and 6.

As can best been seen in a side view provided by FIG. 2 and the rear view provided by FIG. 6, the top and bottom C-shaped portions 110,130 overlie each other and extend in substantially parallel, substantially horizontally extending planes 109,139. As can be seen in the front and rear views provided by FIGS. 4 and 6, respectively, the left and right side C-shaped portions 120, 140, respectively, extend in spaced, substantially vertically extending, non-parallel planes 129, 149,—which is to say that the C-shaped side portions 120, 140 are more widely spaced near the front of the lid support and positioner 100 than near the rear of the lid support and positioner 100.

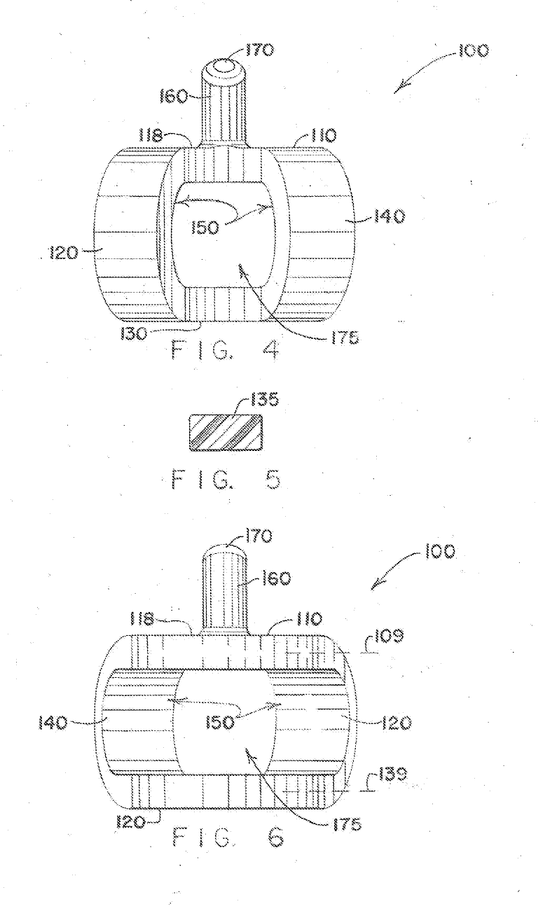

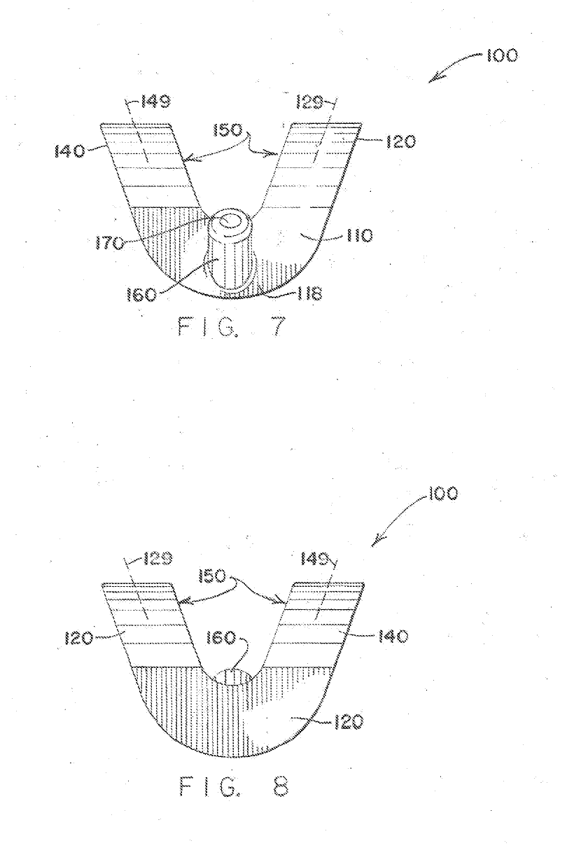

The top, left side, bottom, and right side C-shaped portions 110, 120, 130, 140, respectively, of the endless loop or annular ring of the lid support or positioner 100 all have cross-sectional areas that are substantially equal, but the shape or configuration of the various cross-sections of the resilient material that forms the C-shaped portions 110, 120, 130, 140 differ somewhat along the length of the endless loop or annular ring 150. For example, as viewed in FIG. 3, the C-shaped left and right side portions 120,140 have substantially identically sized cross-sectional areas 125,145, respectively, that are of different substantially trapezoidal shape. And, as viewed in FIG. 5, the C-shaped bottom portion 130 has a cross-section that is substantially rectangular in shape (with slightly rounded corners), but has an area 135 that is substantially the same as that of the trapezoidal cross-sectional areas 125, 145 shown in FIG. 3.

As can easily be seen in FIGS. 1, 2, 4 and 5, the lid support and positioner embodiment 100 has a elongate projection 160 that extends upwardly but at a forwardly inclined angle from a centrally located part 118 of the C-shaped top portion 110. The projection 160 is of substantially uniform, generally cylindrical cross-section, and has a rounded upper end region 170. Other possible embodiments of the present invention may have more projections, or none at all, as maybe appropriate for use with particular cooking vessels.

The resilient character of the material from which the lid positioner 100 is fabricated permits various opposed parts and portions of the positioner 100 to move toward and away from each other. For example, the opposed C-shaped top and bottom portions 110, 120, respectively, and the opposed left and right portions 130, 140, respectively, can move short distances toward and away from each other to permit and object such as a handle of a particular cooking pan to be inserted therebetween even if the size of the handle is slightly larger than the spacings between the top and bottom portions 110, 130, respectively, or between the left and right side portions 120, 140, respectively. Stated in another way, the configuration of the resilient lid support and positioner 100 can be modified to enlarge or adjust the shape and size of the central opening 175.

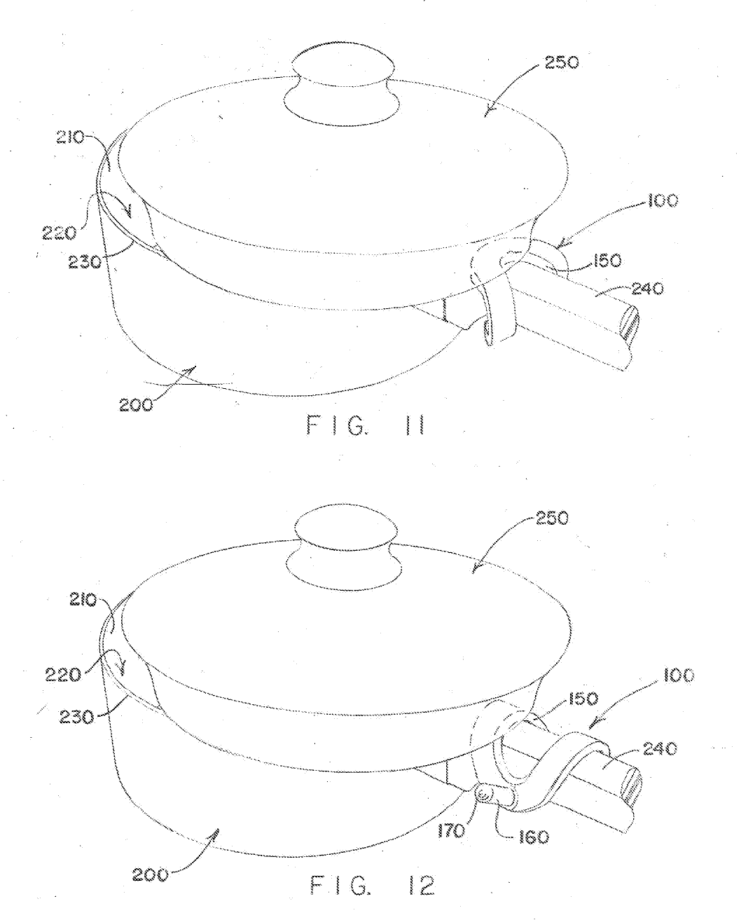

Referring to FIGS. 9-12, cooking vessels 200 of identical form are shown. In FIGS. 13-14, differently configured but identical coking vessels 300 are shown. As will become apparent of the following discussion of what is depicted in FIGS. 10-14, the lid support and positioner 100 may be installed in a wide variety of ways on the handles of cooking vessels of a wide variety of types to provide support for, and to assist in the off-center positioning lids or covers of a wide variety of configurations.

Each of the identical cooking vessels 200 depicted in FIGS. 9-12 has an upstanding sidewall 210 that surrounds an upwardly opening cooking chamber 220. The sidewalls 210 each have top surfaces or rims 230 that encircle an associated cooking chambers 220. Elongate handles 240 connect at one end with an exterior surface of each of upstanding sidewalls 210 of the cooking vessels 200 shown in FIGS. 9-12.

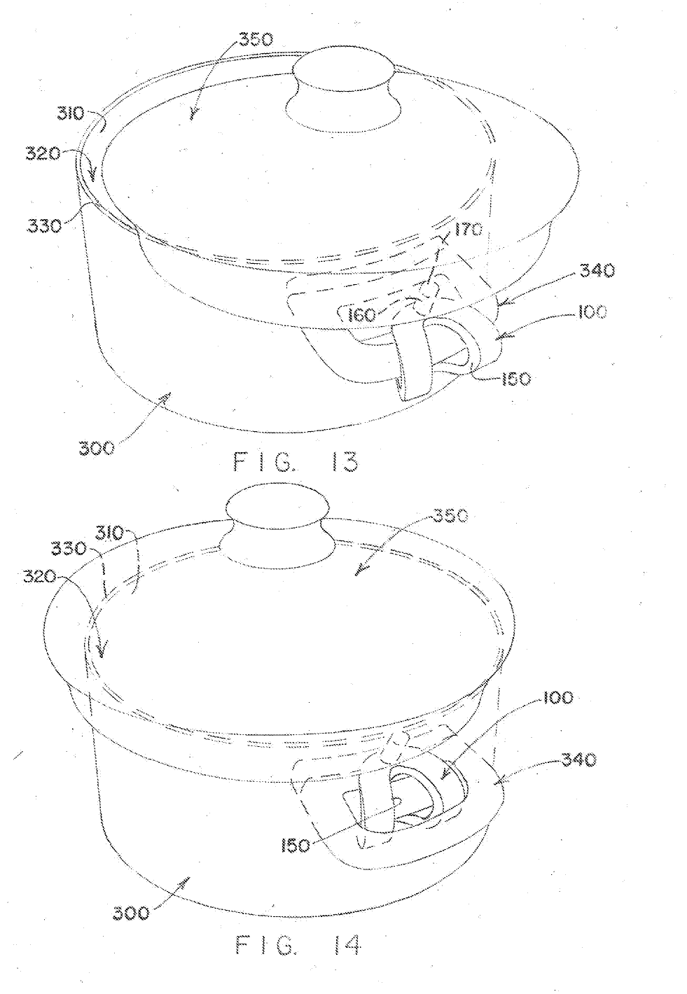

Shown in each of FIGS. 10-12 is the lid support and positioners 100 which installed on or draped over an associated one the elongate handles 240. In FIGS. 10 and 11, the depicted handle 240 extends through the center opening 160 of the depicted lid support and positioner 100. In FIG. 12 the lid support and positioner is draped over the associated handle 240. In each of FIGS. 10, 11 and 12 the lid support and positioner 100 serves to underlie, engage, support and position a portion of a off-center lid 250 that extends outside the perimeter of the associated upwardly opening cooking chamber 220.

In FIG. 10, the depicted upstanding projection 160 of the depicted lid support and positioner 100 can be seen to extend upwardly inside a peripheral region 270 of the associated lid or cover 250. In FIG. 11, the depicted upstanding projection 160 depends downwardly in an out-of-the-way position. In FIG. 12, the upstanding projection 160 can be seen to extend leftwardly relative to the handle 240, in an out-of-the-way position.

Each of the identical cooking vessels 300 depicted in FIGS. 13-14 has an upstanding sidewall 310 that surrounds an upwardly opening cooking chamber 320. The sidewalls 310 each have tops surfaces or rims 330 that encircle an associated cooking chambers 320. Variously configured handles 340 connect with an exterior surface of each of the upstanding sidewalls 310 of the cooking vessels 300 shown in FIGS. 13-14.

In FIGS. 13 and 14, the lid support and positioner 100 is shown installed at different locations on one of the handles 340. In FIG. 13, the upstanding projection 160 of the lid support and positioner 100 extends upwardly inside a peripheral region of the associated lid or cover 350. In FIG. 14, the projection 160 is shown extending downwardly in an out-of-the-way position.

As those skilled in the art will readily understand and appreciate, a significant feature of the present invention resides in providing a simple, easy to use form of lid support and positioner that can be used with cooking vessel handles of many configurations to underlie and provide support, and possibly also to aid in positioning a an off-center lid or cover of the vessel so that the lid or cover will be better supported than if an off-center lid were attempted to be held in balance without form of over-the-handle support for portions of lids or covers that extend beyond the perimeter of the cooking chambers of cooking vessel.

Although the invention has been described in a preferred form with a certain degree of particularity, it is understood that the present disclosure of the preferred form has been made only by way of example, and that numerous changes in the details of construction and the combination and arrangement of parts may be resorted to without departing from the spirit and scope of the invention as hereinafter claimed. It is intended to protect whatever features of patentable novelty exist in the invention disclosed.

1. A lid support and positioner configured to overlie a handle of a cooking vessel to provide and upwardly facing support surface configured to underlie, engage and support a perimeter portion of an off-center lid or cover for the cooking vessel that extends beyond a perimeter of an upwardly opening cooking chamber of the cooking vessel.

2. A lid support and positioner configured to receive a handle of a cooking vessel and to provide an upwardly facing support surface configured to underlie, engage and support a perimeter portion of an off-center lid or cover for the cooking vessel that extends beyond a perimeter of an upwardly opening cooking chamber of the cooking vessel.

3. A lid support and positioner configured to be installed on a handle of a cooking vessel and to provide an upwardly facing support surface configured to underlie, engage and support a perimeter portion of an off-center lid or cover for the cooking vessel that extends beyond a perimeter of an upwardly opening cooking chamber of the cooking vessel.

4. A lid support and positioner configured to grip a handle of a cooking vessel and to provide an upwardly facing support surface configured to underlie, engage and support a perimeter portion of an off-center lid or cover for the cooking vessel that extends beyond a perimeter of an upwardly opening cooking chamber of the cooking vessel.

5. A lid positioner comprising:
a) a one-piece apparatus of generally angular configuration defined by a non-planar endless ring of resilient material of substantially uniform cross-section;
b) with the endless ring of resilient material being defined by a continuous sequence of four substantially C-shaped portions including a generally C-shaped top portion having opposite end regions connected substantially smoothly to opposite end regions of a generally C-shaped bottom portion by substantially C-shaped left portion and a substantially C-shaped right;
c) with the substantially C-shaped top portion extending in a substantially horizontal plane substantially overlying and extending substantially parallel to the substantially C-shaped bottom portion;
d) with the substantially c-shaped left and right portions extending in spaced, substantially vertical extending planes; and,
e) with an elongate projection connected at one end region to, and extending upwardly from and inclined relative to a generally horizontally extending top surface of the substantially C-shaped top portion at a location substantially mid-way along the length of a top surface of the top portion.

6. The lid positioner of claim 5 wherein the resilient material of the apparatus has a memory that tends to force the left and right side portions toward each other so as to grip an elongate handle of a cooking vessel if the left and right side portions are wedged apart a short distance by inserting a cooking vessel handle therebetween, by which arrangement the lid positioner will attempt to maintain a fixed position on the cooking vessel handle and in an orientation causing the elongate projection to extend upwardly to provide a formation that can engage a peripheral portion of a lid of the cooking vessel that has been positioned to partially overlie the handle while not fully overlying an upwardly opening cooking compartment of the cooking vessel.

7. A lid positioner defined by an angular ring of resilient material extending abut an opening configured to permit an elongate handle of a cooking vessel to extend therethrough, with the lid positioner being adapted to resiliently grip opposite side regions of the handle to retain the lid positioner thereon, with the lid positioner having an elongate projection extending away from an exterior surface of the lid positioner for engaging a peripheral portion of a lid cover that extends outside the cooking chamber of a vessel, and to assist in retaining the lid in a position supported atop and partially overlying a portion of the handle.
